(19) United States
(12) Patent Application Publication
(10) Pub. No.: US 2026/0038335 A1
(43) Pub. Date: Feb. 5, 2026

(54) ARTIFICIAL INTELLIGENCE FOR ABNORMAL BETTING BEHAVIORS

(71) Applicant: IGT, Las Vegas, NV (US)

(72) Inventors: Sylvie Roussel, Moncton (CA); Richard Savoie, Moncton (CA)

(21) Appl. No.: 18/791,778

(22) Filed: Aug. 1, 2024

(51) Int. Cl. G07F 17/32; G06N 20/00

(52) U.S. Cl. CPC G07F 17/3237; G06N 20/00; G07F 17/323

(57) ABSTRACT

Embodiments of the present disclosure are directed to monitoring a player of an electronic game and applying responsible gaming features by using Artificial Intelligence (AI) to detect abnormal betting behaviors. Monitoring a player of an electronic game can include training a player model for the player of the electronic game based on a history of gaming activity by the player. The player model can represent patterns of behavior for the player. Game play information for a gaming session of the electronic game can be received while the player is playing the electronic game and any deviation by the player from the patterns of behavior represented in the player model can be detected. In response to detecting the deviation an electronic message can be provided to the player indicating the detected deviation.

### BACKGROUND

The present disclosure is generally directed to monitoring a player of an electronic game and more particularly to applying responsible gaming features.

Responsible gaming is an important aspect in the gaming industry to prevent unhealthy play behavior such as players overspending their play budget. Many initiatives have been established to support responsible gaming, such as setting wager thresholds or being observed by casino staff. Those, however, require either the player and/or operator to initially set the thresholds and/or require manual efforts to be identified or triggered.

### BRIEF SUMMARY

Embodiments of the present disclosure are directed to monitoring a player of an electronic game and applying responsible gaming features by using Artificial Intelligence (AI) to detect abnormal betting behaviors. According to one embodiment, a method for monitoring a player of an electronic game can comprise training a player model for the player of the electronic game based on a history of gaming activity by the player. The player model can represent patterns of behavior for the player. Game play information for a gaming session of the electronic game can be received while the player is playing the electronic game. A deviation by the player from the patterns of behavior represented in the player model can be detected based on the player model and the received game play information. The detected deviation by the player from the patterns of behavior represented in the player model can comprise a deviation from a pattern of bet amounts, a deviation from a pattern of number of games played in succession, a deviation from a pattern of game play pace, and/or others.

In response to detecting the deviation by the player from the patterns of behavior represented in the player model, an electronic message indicating the detected deviation can be provided. For example, providing the electronic message indicating the detected deviation can comprise providing the electronic message to the gaming system. In another example, providing the electronic message indicating the detected deviation can comprise providing the electronic message to a mobile device of the player. In some cases, the electronic message can further comprise an indication of an option to continue receiving messages when deviations by the player from the patterns of behavior represented in the player model are detected.

According to another embodiment, a system can comprise a processor and a memory coupled with and readable by the processor. The memory can store therein a set of instructions which, when executed by the processor, can cause the processor to train a player model for a player of an electronic game based on a history of gaming activity by the player. The player model can represent patterns of behavior for the player. The instructions can further cause the processor to receive, from a gaming system, game play information for a gaming session of the electronic game while the player is playing the electronic game and detect, based on the player model and the received game play information, a deviation by the player from the patterns of behavior represented in the player model. The detected deviation by the player from the patterns of behavior represented in the player model can comprise a deviation from a pattern of bet amounts, a deviation from a pattern of number of games played in succession, a deviation from a pattern of game play pace, and/or others.

In response to detecting the deviation by the player from the patterns of behavior represented in the player model, the instructions can further cause the processor to provide an electronic message indicating the detected deviation. For example, providing the electronic message indicating the detected deviation can comprise providing the electronic message to the gaming system. In another example, providing the electronic message indicating the detected deviation can comprise providing the electronic message to a mobile device of the player. In some cases, the electronic message can further comprise an indication of an option to continue receiving messages when deviations by the player from the patterns of behavior represented in the player model are detected.

According to yet another embodiment, a system can comprise a communications network, a plurality of gaming systems coupled with the communications network, and a responsible gaming system coupled with the communications network. The responsible gaming system can comprise a processor and a memory coupled with and readable by the processor and storing therein a set of instructions which, when executed by the processor, causes the processor to train a player model for a player based on a history of gaming activity by the player on the plurality of gaming systems. The player model representing patterns of behavior for the player. The responsible gaming system can further receive, from a gaming system of the plurality of gaming systems, via the communications network, game play information for a gaming session of an electronic game executed by the gaming system while the player is playing the electronic game and detect, based on the player model and the received game play information, a deviation by the player from the patterns of behavior represented in the player model.

In response to detecting the deviation by the player from the patterns of behavior represented in the player model, the responsible gaming system can provide an electronic message indicating the detected deviation. For example, providing the electronic message indicating the detected deviation can comprise providing the electronic message to the gaming system. In another example, providing the electronic message indicating the detected deviation can comprise providing the electronic message to a mobile device of the player. In some cases, the electronic message can further comprise an indication of an option to continue receiving messages when deviations by the player from the patterns of behavior represented in the player model are detected.

Additional features and advantages are described herein and will be apparent from the following Description and the figures.

### BRIEF DESCRIPTION OF THE SEVERAL VIEWS OF THE DRAWINGS

FIG. 1 is a block diagram illustrating an exemplary environment in which embodiments of the present disclosure can be implemented.

FIG. 2 is a block diagram illustrating additional details of components of an exemplary responsible gaming system according to one embodiment of the present disclosure.

FIG. 3 is a flowchart illustrating an exemplary process for monitoring a player and applying responsible gaming features according to one embodiment of the present disclosure.

FIG. 4 is a flowchart illustrating an exemplary process for monitoring a player and applying responsible gaming features according to another embodiment of the present disclosure.

### DETAILED DESCRIPTION

Embodiments of the present disclosure are directed to monitoring a player of an electronic game and applying responsible gaming features by using Artificial Intelligence (AI) to detect abnormal betting behaviors. More specifically, embodiments of the present disclosure are directed to an AI with the ability to notify a player of abnormal betting behavior by that player based on past betting behaviors. The AI can track the betting behavior of the player overall or per game. The AI can know on average how much a player wagers and how much money he/she usually plays. If at any point, this becomes higher than usual for a certain period of time, a prompt message can be provided to the player, e.g., “Your average bet on this game historically has been $X.XX. Today, it is up by Y % and is now $X.XX.” This would at least indicate to the player to be mindful of his/her betting habits. The player could decide to change their bet at that point. According to one embodiment, after this first prompt, or along with it, an option can be presented to the player, e.g., a note saying: “Would you like to continue receiving these messages?” to which the player could say Yes or No. Additionally, or alternatively, this feature can be setup as part of a responsible gaming program configuration. In either case, these features can be provided as an option the player decides to opt into or out off, e.g., when signing up for a player card.

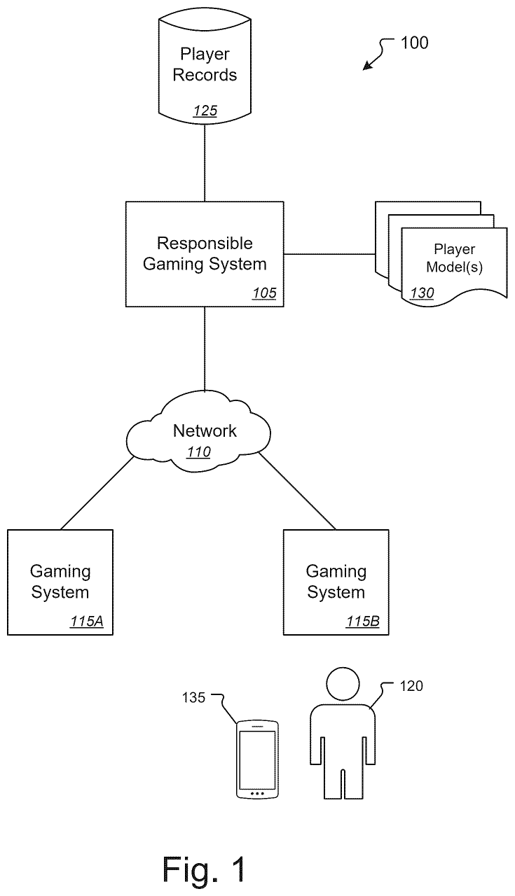

FIG. 1 is a block diagram illustrating an exemplary environment in which embodiments of the present disclosure can be implemented. As illustrated in this example, the environment 100 can comprise a responsible gaming system 105 coupled with a communications network 110. Generally speaking, the responsible gaming system 105 can comprise any one or more servers and/or other computing devices as known in the art. The communications network 110 can comprise any one or more wired and/or wireless, local-area and/or wide-area networks as known in the art including, but not limited to, the Internet. Also coupled with the communications network 110 can be any number of gaming systems 115A-115B. Generally speaking, each gaming system 115 can comprise, for example, any Electronic Gaming Machine (EGM), kiosk, or similar gaming system as may be found in a casino or other gaming venue. The gaming system 115 can each execute any of a variety of electronic games including, but not limited to slots, video slots, video poker, keno, etc.

According to one embodiment, the responsible gaming system 105 can collect and maintain historical gaming information for a player 120 in a set of player records 125. The responsible gaming system 105 can use the historical information in the player records 125 to train a player model 130 for the player 120. The player model 130 can represent patterns of behavior for the player 120 based on the player's history of gaming activity on the plurality of gaming systems 115A-115B. The responsible gaming system 105 can further receive, from a gaming system 115B of the plurality of gaming systems 115A-115B, via the communications network 110, game play information for a gaming session of an electronic game executed by the gaming system 115B while the player 120 is playing the electronic game. Based on the player model 130 and the received game play information, the responsible gaming system 105 can detect any deviation by the player from the patterns of behavior represented in the player model.

In response to detecting a deviation by the player from the patterns of behavior represented in the player model, the responsible gaming system 105 can provide an electronic message indicating the detected deviation. For example, providing the electronic message indicating the detected deviation can comprise providing the electronic message to the gaming system 115B. In another example, providing the electronic message indicating the detected deviation can comprise providing the electronic message to a mobile device 135 of the player. In some cases, the electronic message can further include an indication of an option to continue receiving messages when deviations by the player 120 from the patterns of behavior represented in the player model 130 are detected.

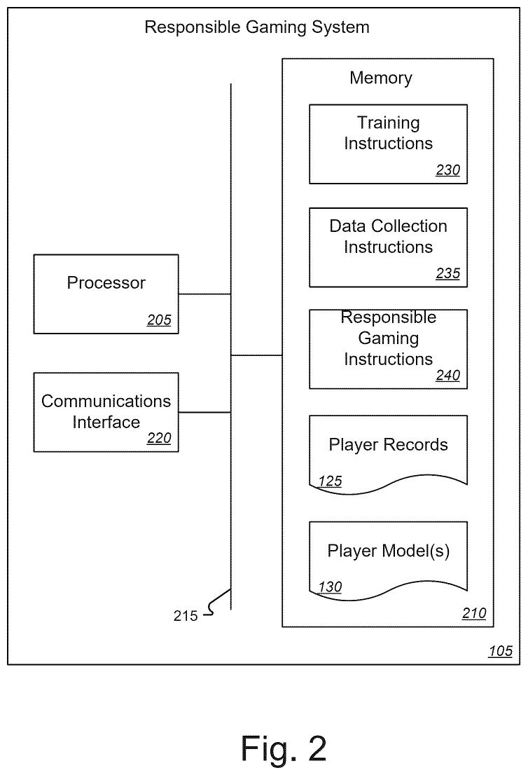

FIG. 2 is a block diagram illustrating additional details of components of an exemplary responsible gaming system according to one embodiment of the present disclosure. As illustrated in this example, a responsible gaming system 105 such as described above can comprise a processor 205. The processor 205 may correspond to one or many computer processing devices. For instance, the processor 205 may be provided as silicon, as a Field Programmable Gate Array (FPGA), an Application-Specific Integrated Circuit (ASIC), any other type of Integrated Circuit (IC) chip, a collection of IC chips, or the like. As a more specific example, the processor 205 may be provided as a microprocessor, Central Processing Unit (CPU), or plurality of microprocessors that are configured to execute the instructions sets stored in a memory 210. Upon executing the instruction sets stored in memory 210, the processor 205 enables various functions of the responsible gaming system 105 as described herein.

The memory 210 can be coupled with and readable by the processor 205 via a communications bus 215. The memory 210 may include any type of computer memory device or collection of computer memory devices. Non-limiting examples of memory 210 include Random Access Memory (RAM), Read Only Memory (ROM), flash memory, Electronically-Erasable Programmable ROM (EEPROM), Dynamic RAM (DRAM), etc. The memory 210 may be configured to store the instruction sets depicted in addition to temporarily storing data for the processor 205 to execute various types of routines or functions.

The processor 205 can also be coupled with one or more communication interface(s) 220 via the communications bus 215. The communication interface(s) 220 can comprise, for example, an Ethernet, Bluetooth, WiFi, cellular, and/or other type of wired and/or wireless communications interface. Via the communication interface(s) 220, the responsible gaming system 105 can communicate with other devices and/or systems through a communications network 110 as described above.

The memory 210 can store therein a set of training instructions 230 which, when executed by the processor 205, cause the processor 205 to train a player model 130 for a player 120 of an electronic game based on player records 125 indicating a history of gaming activity by the player 120. The player model 130 can represent patterns of behavior for the player 120.

The memory 210 can also have stored therein a set of data collection instructions 235. The data collection instructions 235, when executed by the processor 205, can further cause the processor 205 to receive, from a gaming system 115B, through the communications interface 220, game play information for a gaming session of the electronic game while the player 120 is playing the electronic game.

The memory 210 can also have stored therein a set of responsible gaming instructions 240. The responsible gaming instructions 240, when executed by the processor 205, can further cause the processor 205 to detect, based on the player model 130 and the received game play information, a deviation by the player 120 from the patterns of behavior represented in the player model 130. The detected deviation by the player from the patterns of behavior represented in the player model can comprise, for example, a deviation from a pattern of bet amounts, a deviation from a pattern of number of games played in succession, a deviation from a pattern of game play pace, and/or others.

In response to detecting the deviation by the player 120 from the patterns of behavior represented in the player model 130, the responsible gaming instructions 240 can further cause the processor 205 to provide, through the communications interface 220, an electronic message indicating the detected deviation. For example, providing the electronic message indicating the detected deviation can comprise providing the electronic message to the gaming system 115B. In another example, providing the electronic message indicating the detected deviation can comprise providing the electronic message to a mobile device 135 of the player 120. In some cases, the electronic message can further include an indication of an option to continue receiving messages when deviations by the player 120 from the patterns of behavior represented in the player model 130 are detected.

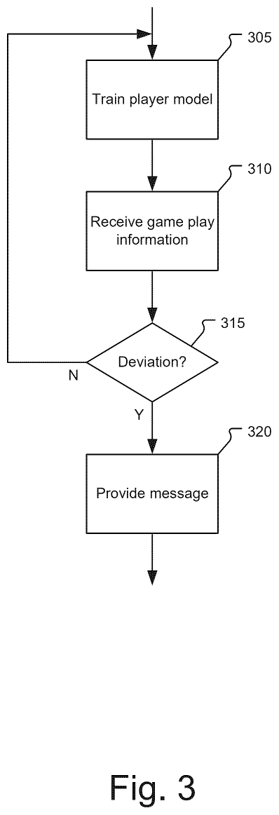

FIG. 3 is a flowchart illustrating an exemplary process for monitoring a player and applying responsible gaming features according to one embodiment of the present disclosure. As illustrated in this example, monitoring a player of an electronic game can comprise training 305 a player model 130 for the player 120 of the electronic game based on a history of gaming activity by the player 120. The player model 130 can represent patterns of behavior for the player 120. Game play information for a gaming session of the electronic game can be received 310 while the player is playing the electronic game.

A determination 315 can be made as to whether a deviation by the player 120 from the patterns of behavior represented in the player model 130 has been detected based on the player model 130 and the received game play information. The detected deviation by the player from the patterns of behavior represented in the player model can comprise a deviation from a pattern of bet amounts, a deviation from a pattern of number of games played in succession, a deviation from a pattern of game play pace, and/or others.

In response to detecting 315 the deviation by the player from the patterns of behavior represented in the player model, an electronic message indicating the detected deviation can be provided 320. For example, providing 320 the electronic message indicating the detected deviation can comprise providing the electronic message to the gaming system. In another example, providing 320 the electronic message indicating the detected deviation can comprise providing the electronic message to a mobile device of the player.

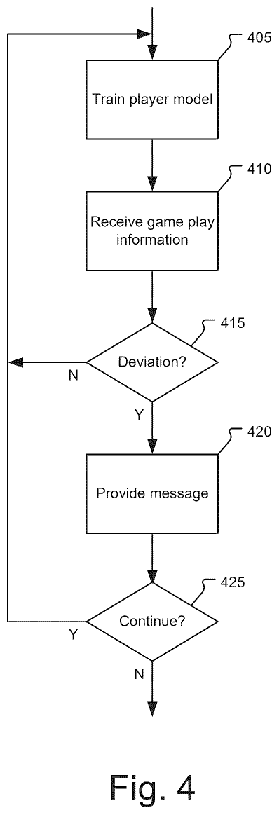

FIG. 4 is a flowchart illustrating an exemplary process for monitoring a player and applying responsible gaming features according to another embodiment of the present disclosure. As illustrated in this example, monitoring a player of an electronic game can comprise training 405 a player model 130 for the player 120 of the electronic game based on a history of gaming activity by the player 120. The player model 130 can represent patterns of behavior for the player 120. Game play information for a gaming session of the electronic game can be received 410 while the player is playing the electronic game.

A determination 415 can be made as to whether a deviation by the player 120 from the patterns of behavior represented in the player model 130 has been detected based on the player model 130 and the received game play information. The detected deviation by the player from the patterns of behavior represented in the player model can comprise a deviation from a pattern of bet amounts, a deviation from a pattern of number of games played in succession, a deviation from a pattern of game play pace, and/or others.

In response to detecting 415 the deviation by the player from the patterns of behavior represented in the player model, an electronic message indicating the detected deviation can be provided 420. For example, providing 420 the electronic message indicating the detected deviation can comprise providing the electronic message to the gaming system. In another example, providing 420 the electronic message indicating the detected deviation can comprise providing the electronic message to a mobile device of the player.

In some cases, the electronic message can comprise an indication of an option to continue receiving messages when deviations by the player from the patterns of behavior represented in the player model are detected. In such cases, a determination 425 can be made, e.g., in response to a user clicking a button or link in a user interface through which the option is presented and indicating acceptance or rejection of the option, as to whether the player 120 wishes to continue receiving such messages. In response to determining 425 the player has accepted the option to continue receiving messages, processing can continue with training 405 the player model, receiving 410 game play information, and providing 420 the messages whenever a deviation is detected 415.

A number of variations and modifications of the disclosure can be used. It would be possible to provide for some features of the disclosure without providing others.

The present disclosure contemplates a variety of different gaming systems each having one or more of a plurality of different features, attributes, or characteristics. A “gaming system” as used herein refers to various configurations of: (a) one or more central servers, central controllers, or remote hosts; (b) one or more electronic gaming machines such as those located on a casino floor; and/or (c) one or more personal gaming devices, such as desktop computers, laptop computers, tablet computers or computing devices, personal digital assistants, mobile phones, and other mobile computing devices. Moreover, an EGM as used herein refers to any suitable electronic gaming machine which enables a player to play a game (including but not limited to a game of chance, a game of skill, and/or a game of partial skill) to potentially win one or more awards, wherein the EGM comprises, but is not limited to: a slot machine, a video poker machine, a video lottery terminal, a terminal associated with an electronic table game, a video keno machine, a video bingo machine located on a casino floor, a sports betting terminal, or a kiosk, such as a sports betting kiosk.

In various embodiments, the gaming system of the present disclosure includes: (a) one or more electronic gaming machines in combination with one or more central servers, central controllers, or remote hosts; (b) one or more personal gaming devices in combination with one or more central servers, central controllers, or remote hosts; (c) one or more personal gaming devices in combination with one or more electronic gaming machines; (d) one or more personal gaming devices, one or more electronic gaming machines, and one or more central servers, central controllers, or remote hosts in combination with one another; (e) a single electronic gaming machine; (f) a plurality of electronic gaming machines in combination with one another; (g) a single personal gaming device; (h) a plurality of personal gaming devices in combination with one another; (i) a single central server, central controller, or remote host; and/or (j) a plurality of central servers, central controllers, or remote hosts in combination with one another.

For brevity and clarity and unless specifically stated otherwise, “EGM” as used herein represents one EGM or a plurality of EGMs, “personal gaming device” as used herein represents one personal gaming device or a plurality of personal gaming devices, and “central server, central controller, or remote host” as used herein represents one central server, central controller, or remote host or a plurality of central servers, central controllers, or remote hosts.

As noted above, in various embodiments, the gaming system includes an EGM (or personal gaming device) in combination with a central server, central controller, or remote host. In such embodiments, the EGM (or personal gaming device) is configured to communicate with the central server, central controller, or remote host through a data network or remote communication link. In certain such embodiments, the EGM (or personal gaming device) is configured to communicate with another EGM (or personal gaming device) through the same data network or remote communication link or through a different data network or remote communication link. For example, the gaming system includes a plurality of EGMs that are each configured to communicate with a central server, central controller, or remote host through a data network.

In certain embodiments in which the gaming system includes an EGM (or personal gaming device) in combination with a central server, central controller, or remote host, the central server, central controller, or remote host is any suitable computing device (such as a server) that includes at least one processor and at least one memory device or data storage device. As further described herein, the EGM (or personal gaming device) includes at least one EGM (or personal gaming device) processor configured to transmit and receive data or signals representing events, messages, commands, or any other suitable information between the EGM (or personal gaming device) and the central server, central controller, or remote host. The at least one processor of that EGM (or personal gaming device) is configured to execute the events, messages, or commands represented by such data or signals in conjunction with the operation of the EGM (or personal gaming device). Moreover, the at least one processor of the central server, central controller, or remote host is configured to transmit and receive data or signals representing events, messages, commands, or any other suitable information between the central server, central controller, or remote host and the EGM (or personal gaming device). The at least one processor of the central server, central controller, or remote host is configured to execute the events, messages, or commands represented by such data or signals in conjunction with the operation of the central server, central controller, or remote host. One, more than one, or each of the functions of the central server, central controller, or remote host may be performed by the at least one processor of the EGM (or personal gaming device). Further, one, more than one, or each of the functions of the at least one processor of the EGM (or personal gaming device) may be performed by the at least one processor of the central server, central controller, or remote host.

In certain such embodiments, computerized instructions for controlling any games (such as any primary or base games and/or any secondary or bonus games) displayed by the EGM (or personal gaming device) are executed by the central server, central controller, or remote host. In such “thin client” embodiments, the central server, central controller, or remote host remotely controls any games (or other suitable interfaces) displayed by the EGM (or personal gaming device), and the EGM (or personal gaming device) is utilized to display such games (or suitable interfaces) and to receive one or more inputs or commands. In other such embodiments, computerized instructions for controlling any games displayed by the EGM (or personal gaming device) are communicated from the central server, central controller, or remote host to the EGM (or personal gaming device) and are stored in at least one memory device of the EGM (or personal gaming device). In such “thick client” embodiments, the at least one processor of the EGM (or personal gaming device) executes the computerized instructions to control any games (or other suitable interfaces) displayed by the EGM (or personal gaming device).

In various embodiments in which the gaming system includes a plurality of EGMs (or personal gaming devices), one or more of the EGMs (or personal gaming devices) are thin client EGMs (or personal gaming devices) and one or more of the EGMs (or personal gaming devices) are thick client EGMs (or personal gaming devices). In other embodiments in which the gaming system includes one or more EGMs (or personal gaming devices), certain functions of one or more of the EGMs (or personal gaming devices) are implemented in a thin client environment, and certain other functions of one or more of the EGMs (or personal gaming devices) are implemented in a thick client environment. In one such embodiment in which the gaming system includes an EGM (or personal gaming device) and a central server, central controller, or remote host, computerized instructions for controlling any primary or base games displayed by the EGM (or personal gaming device) are communicated from the central server, central controller, or remote host to the EGM (or personal gaming device) in a thick client configuration, and computerized instructions for controlling any secondary or bonus games or other functions displayed by the EGM (or personal gaming device) are executed by the central server, central controller, or remote host in a thin client configuration.

In certain embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a local area network (LAN) in which the EGMs (or personal gaming devices) are located substantially proximate to one another and/or the central server, central controller, or remote host. In one example, the EGMs (or personal gaming devices) and the central server, central controller, or remote host are located in a gaming establishment or a portion of a gaming establishment.

In other embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a wide area network (WAN) in which one or more of the EGMs (or personal gaming devices) are not necessarily located substantially proximate to another one of the EGMs (or personal gaming devices) and/or the central server, central controller, or remote host. For example, one or more of the EGMs (or personal gaming devices) are located: (a) in an area of a gaming establishment different from an area of the gaming establishment in which the central server, central controller, or remote host is located; or (b) in a gaming establishment different from the gaming establishment in which the central server, central controller, or remote host is located. In another example, the central server, central controller, or remote host is not located within a gaming establishment in which the EGMs (or personal gaming devices) are located. In certain embodiments in which the communication network includes a WAN, the gaming system includes a central server, central controller, or remote host and an EGM (or personal gaming device) each located in a different gaming establishment in a same geographic area, such as a same city or a same state. Gaming systems in which the communication network includes a WAN are substantially identical to gaming systems in which the communication network includes a LAN, though the quantity of EGMs (or personal gaming devices) in such gaming systems may vary relative to one another.

In further embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include an internet (such as the Internet) or an intranet. In certain such embodiments, an Internet browser of the EGM (or personal gaming device) is usable to access an Internet game page from any location where an Internet connection is available. In one such embodiment, after the EGM (or personal gaming device) accesses the Internet game page, the central server, central controller, or remote host identifies a player before enabling that player to place any wagers on any plays of any wagering games. In one example, the central server, central controller, or remote host identifies the player by requiring a player account of the player to be logged into via an input of a unique player name and password combination assigned to the player. The central server, central controller, or remote host may, however, identify the player in any other suitable manner, such as by validating a player tracking identification number associated with the player; by reading a player tracking card or other smart card inserted into a card reader; by validating a unique player identification number associated with the player by the central server, central controller, or remote host; or by identifying the EGM (or personal gaming device), such as by identifying the MAC address or the IP address of the Internet facilitator. In various embodiments, once the central server, central controller, or remote host identifies the player, the central server, central controller, or remote host enables placement of one or more wagers on one or more plays of one or more primary or base games and/or one or more secondary or bonus games, and displays those plays via the Internet browser of the EGM (or personal gaming device). Examples of implementations of Internet-based gaming are further described in U.S. Pat. No. 8,764,566, entitled “Internet Remote Game Server,” and U.S. Pat. No. 8,147,334, entitled “Universal Game Server.”

The central server, central controller, or remote host and the EGM (or personal gaming device) are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile Internet network), or any other suitable medium. The expansion in the quantity of computing devices and the quantity and speed of Internet connections in recent years increases opportunities for players to use a variety of EGMs (or personal gaming devices) to play games from an ever-increasing quantity of remote sites. Additionally, the enhanced bandwidth of digital wireless communications may render such technology suitable for some or all communications, particularly if such communications are encrypted. Higher data transmission speeds may be useful for enhancing the sophistication and response of the display and interaction with players.

As should be appreciated by one skilled in the art, aspects of the present disclosure have been illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (Saas).

Aspects of the present disclosure have been described herein with reference to flowchart illustrations and/or block diagrams of methods, apparatuses (systems) and computer program products according to embodiments of the disclosure. It should be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

What is claimed is:

1. A method for monitoring a player of an electronic game, the method comprising:
training, by a responsible gaming server, a player model for the player of the electronic game based on a history of gaming activity by the player, the player model representing patterns of behavior for the player;
receiving, by the responsible gaming server, from a gaming system, game play information for a gaming session of the electronic game while the player is playing the electronic game;
detecting, by the responsible gaming server, based on the player model and the received game play information, a deviation by the player from the patterns of behavior represented in the player model; and
in response to detecting the deviation by the player from the patterns of behavior represented in the player model, providing, by the responsible gaming server, an electronic message indicating the detected deviation.

2. The method of claim 1, wherein providing the electronic message indicating the detected deviation comprises providing the electronic message to the gaming system.

3. The method of claim 1, wherein providing the electronic message indicating the detected deviation comprises providing the electronic message to a mobile device of the player.

4. The method of claim 1, wherein the electronic message further comprises indication of an option to continue receiving messages when deviations by the player from the patterns of behavior represented in the player model are detected.

5. The method of claim 1, wherein the detected deviation by the player from the patterns of behavior represented in the player model comprises a deviation from a pattern of bet amounts.

6. The method of claim 1, wherein the detected deviation by the player from the patterns of behavior represented in the player model comprises a deviation from a pattern of number of games played in succession.

7. The method of claim 1, wherein the detected deviation by the player from the patterns of behavior represented in the player model comprises a deviation from a pattern of game play pace.

8. A system comprising:
a processor; and
a memory coupled with and readable by the processor and storing therein a set of instructions which, when executed by the processor, causes the processor to:
train a player model for a player of an electronic game based on a history of gaming activity by the player, the player model representing patterns of behavior for the player;
receive, from a gaming system, game play information for a gaming session of the electronic game while the player is playing the electronic game;
detect, based on the player model and the received game play information, a deviation by the player from the patterns of behavior represented in the player model; and
in response to detecting the deviation by the player from the patterns of behavior represented in the player model, provide an electronic message indicating the detected deviation.

9. The system of claim 8, wherein providing the electronic message indicating the detected deviation comprises providing the electronic message to the gaming system.

10. The system of claim 8, wherein providing the electronic message indicating the detected deviation comprises providing the electronic message to a mobile device of the player.

11. The system of claim 8, wherein the electronic message further comprises indication of an option to continue receiving messages when deviations by the player from the patterns of behavior represented in the player model are detected.

12. The system of claim 8, wherein the detected deviation by the player from the patterns of behavior represented in the player model comprises a deviation from a pattern of bet amounts.

13. The system of claim 8, wherein the detected deviation by the player from the patterns of behavior represented in the player model comprises a deviation from a pattern of number of games played in succession.

14. The system of claim 8, wherein the detected deviation by the player from the patterns of behavior represented in the player model comprises a deviation from a pattern of game play pace.

15. A system comprising:
a communications network;
a plurality of gaming systems coupled with the communications network; and
a responsible gaming system coupled with the communications network, the responsible gaming system comprising a processor and a memory coupled with and readable by the processor and storing therein a set of instructions which, when executed by the processor, causes the processor to:
train a player model for a player based on a history of gaming activity by the player on the plurality of gaming systems, the player model representing patterns of behavior for the player;
receive, from a gaming system of the plurality of gaming systems, via the communications network, game play information for a gaming session of an electronic game executed by the gaming system while the player is playing the electronic game;
detect, based on the player model and the received game play information, a deviation by the player from the patterns of behavior represented in the player model; and
in response to detecting the deviation by the player from the patterns of behavior represented in the player model, provide an electronic message indicating the detected deviation to the gaming system via the communications network.

16. The system of claim 15, wherein the instructions further cause the processor to provide an electronic message indicating the detected deviation to a mobile device of the player.

17. The system of claim 15, wherein the electronic message further comprises indication of an option to continue receiving messages when deviations by the player from the patterns of behavior represented in the player model are detected.

18. The system of claim 15, wherein the detected deviation by the player from the patterns of behavior represented in the player model comprises a deviation from a pattern of bet amounts.

19. The system of claim 15, wherein the detected deviation by the player from the patterns of behavior represented in the player model comprises a deviation from a pattern of number of games played in succession.

20. The system of claim 15, wherein the detected deviation by the player from the patterns of behavior represented in the player model comprises a deviation from a pattern of game play pace.
